(19) United States
(12) Patent Application Publication
(10) Pub. No.: US 2014/0366094 A1
(43) Pub. Date: Dec. 11, 2014

(54) COMMUNICATION METHOD, COMMUNICATION APPARATUS AND TERMINAL

(71) Applicant: Tencent Technology (Shenzhen) Company Limited, Shenzhen (CN)

(72) Inventor: Rui Li, Shenzhen (CN)

(21) Appl. No.: 14/328,289

(22) Filed: Jul. 10, 2014

Related U.S. Application Data
(63) Continuation of application No. PCT/CN2014/072545, filed on Feb. 6, 2014.

(30) Foreign Application Priority Data
Jun. 5, 2013 (CN) 201310222250.05

(51) Int. Cl. H04W 12/06

(52) U.S. Cl. CPC H04W 12/06
USPC 726/3

(57) ABSTRACT

The invention provides a communication method, a communication device and a terminal. The method includes: recording a first time point of a first communication performed via a wireless network; and performing a second communication via the wireless network before a duration shorter than or equal to an authentication cooling threshold is elapsed from the first time point, wherein the authentication cooling threshold is associated with a duration in which a valid authentication of the terminal by the wireless network is retained.

The present application is a continuation of PCT/CN2014/072545, filed on Feb. 26, 2014 and entitled “COMMUNICATION METHOD, COMMUNICATION APPARATUS AND TERMINAL”, which claims the priority to Chinese Patent Application No. 201310222250.5, entitled “COMMUNICATION METHOD, COMMUNICATION APPARATUS AND TERMINAL”, filed on Jun. 5, 2013 with State Intellectual Property Office of People's Republic of China, both of which are incorporated herein by reference in entirety.

### TECHNICAL FIELD

The disclosure relates to communication technologies, and in particular, to a communication method, a communication apparatus and a terminal.

### BACKGROUND

Along with the development of the wireless communication technology, more and more users perform communication by using a wireless network. Since the Round-Trip Time (RTT) involved in the communication performed by a terminal using the wireless network is relatively long, people focus on how to shorten the RTT involved in the communication performed by using the wireless network and how to increase the efficiency of the communication.

A conventional communication method includes: when the terminal performs communication with the wireless network, obtaining an access point of the wireless network, establishing a persistent connection based on the access point, and communicating with the wireless network via the persistent connection, by the terminal. After the communication, the terminal maintains the persistent connection with the wireless network in order that the terminal still communicates with the wireless network via the persistent connection for the next time.

The method of maintaining a persistent connection has disadvantages such as large RTT and low efficiency, and there is need for an improvement.

### SUMMARY

In view of the above technical problems, a communication method, a communication apparatus and a terminal are provided according to embodiments of the invention.

In one aspect, the disclosure provides a communication method applicable in a terminal, and the method includes:

recording a first time point of a first communication performed via a wireless network;

performing a second communication via the wireless network before a duration shorter than or equal to an authentication cooling threshold is elapsed from the first time point, wherein the authentication cooling threshold is associated with a duration in which a valid authentication of the terminal by the wireless network is retained.

In another aspect, the disclosure provides a communication apparatus applicable in a terminal and the communication apparatus includes:

a recording module, configured to record a first time point of a first communication performed via a wireless network; and

a communication module, configured to, performing a second communication via the wireless network before a duration shorter than or equal to an authentication cooling threshold is elapsed from the first time point, wherein the authentication cooling threshold is associated with a duration in which a valid authentication of the terminal by the wireless network is retained.

In yet another aspect, the disclosure provides a terminal, where the terminal includes the foregoing communication apparatus.

According to embodiments of the invention, the wireless network is used again in communication before a duration shorter than or equal to the authentication cooling threshold is elapsed from the first time point; therefore, the problem that, a long RTT and a low communication efficiency are involved in a communication with the network if the terminal performs the communication via a persistent connection with the network, is resolved, and the efficiency of the communication is enhanced.

### BRIEF DESCRIPTION OF THE DRAWINGS

For explaining technical solutions according to embodiments of the invention more clearly, drawings needed in the description of the embodiments are explained briefly hereinafter. Obviously, the drawings in the description are merely some of the embodiments of the invention, and other drawings may be obtained by those skilled in the art based on these drawings without creative efforts.

FIG. 1 is a flow chart of a communication method according to an embodiment of the invention.

FIG. 2 is a flow chart of a communication method according to an embodiment of the invention.

FIG. 3 is a flow chart of a communication method according to an embodiment of the invention.

FIG. 4A is a flow chart of a communication method according to an embodiment of the invention.

FIG. 4B is a flow chart of a first method for measuring an authentication cooling threshold according to an embodiment of the invention.

FIG. 4C is a flow chart of a second method for measuring an authentication cooling threshold according to an embodiment of the invention.

FIG. 5 is a block diagram showing the structure of a communication apparatus according to an embodiment of the invention.

FIG. 6 is a block diagram showing the structure of a communication apparatus according to an embodiment of the invention.

FIG. 7 is a block diagram showing the structure of a communication apparatus according to another embodiment of the invention.

FIG. 8 is a block diagram showing the structure of an electronic device according to an embodiment of the invention.

FIG. 9 is a block diagram showing the structure of an electronic device according to another embodiment of the invention.

### DETAILED DESCRIPTION

For better understanding the objectives, technical solution and advantages of the invention, embodiments of the invention are further described in detail hereinafter in conjunction with drawings.

When implementing the disclosure, the inventor finds that, when a terminal communicates with a wireless network again via a persistent connection after a time interval is elapsed since the persistent connection is established, the RTT of the wireless network is short if the time interval is short, and the RTT of the wireless network is long if the time interval is long; therefore, it may be determined that the RTT of the wireless network is related to the duration in which the terminal halts communicating with the wireless network.

In order to improve the security, a terminal is required to be authorized by an authentication device when the terminal accesses the wireless network, and after passing the authentication, the terminal may access the wireless network and communicate with the wireless network. If the terminal does not perform communication by using the wireless network in a time period and the time period is longer than or equal to an authentication cooling threshold, the terminal is required to be authorized again by the authentication device when the terminal needs to perform communication by using the wireless network again, and after the new authentication is passed, the terminal may perform communication by using the wireless network again. The authentication cooling threshold refers to a duration in which a valid authentication is retained since the terminal halts communicating with the wireless network after a successful authentication.

Accordingly, if the duration in which the terminal halts communicating with the wireless network is short, the terminal is not required to be authorized by the authentication device when the terminal communicates with the wireless network again, thus the RTT of the wireless network is short; if the duration in which the terminal halts communicating with the wireless network is long, the terminal is required to be authorized by the authentication device when the terminal communicates with the wireless network again, thus the RTT of the wireless network is long and the efficiency in communication is decreased consequently.

Referring to FIG. 1, a flow chart of a communication method according to an embodiment of the invention is illustrated. The communication method may be applied in a terminal, and includes steps 10 and 11.

In step 10, a first time point of a first communication performed via a wireless network is recorded.

Used herein, the first time point includes any time point during the first communication. In an example, the terminal may record a time point on which the first communication between the terminal and the wireless network is accomplished as the first time point. Of course, the first time point may be other time point during the first communication and the present disclosure is not limited in this aspect.

In step 11, a second communication via the wireless network is performed before a duration shorter than or equal to an authentication cooling threshold is elapsed from the first time point.

As used herein, the authentication cooling threshold is associated with a duration in which a valid authentication of the terminal by the wireless network is retained.

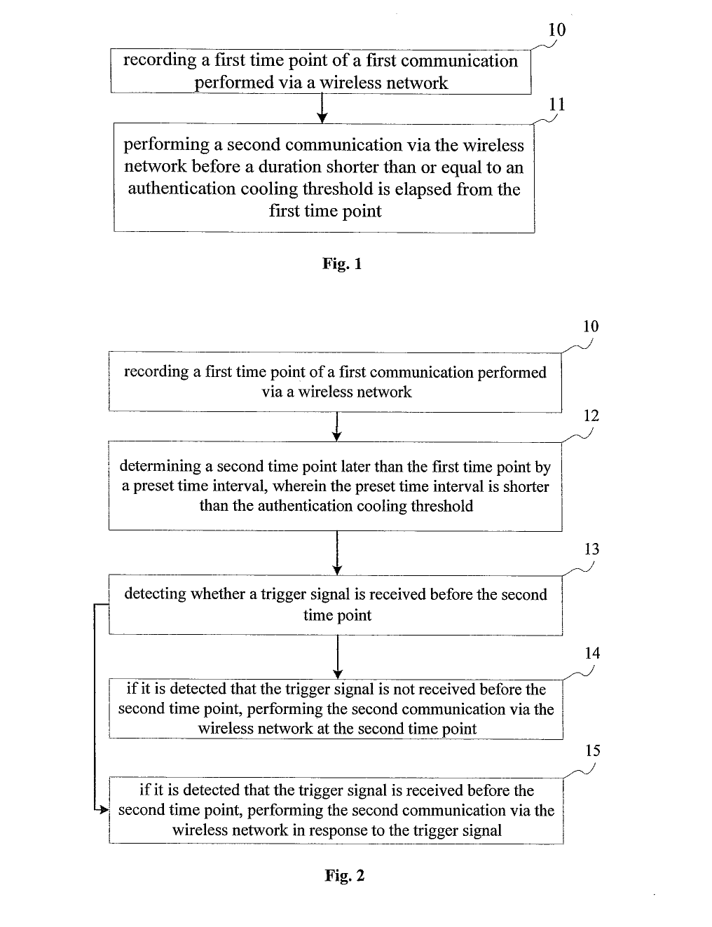

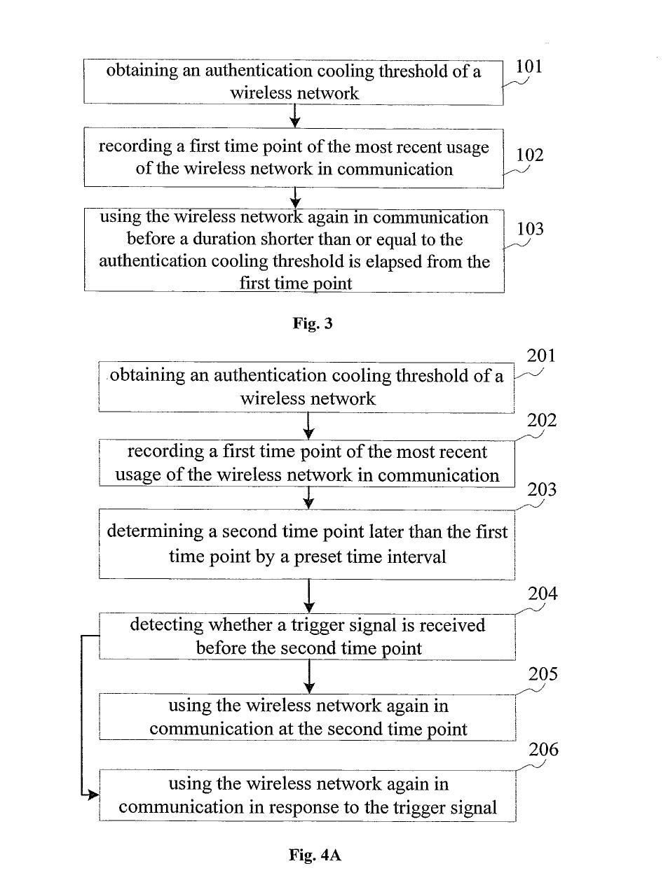

According to another embodiment of the disclosure, the method may further include steps 12-15, as shown in FIG. 2.

In step 12, a second time point later than the first time point by a preset time interval is determined, where the preset time interval is shorter than the authentication cooling threshold.

In step 13, it is detected whether a trigger signal is received before the second time point. For example, the trigger signal is generated in response to a preset operation performed on the terminal.

If it is detected that the trigger signal is not received before the second time point, proceed to step 14 of performing the second communication via the wireless network at the second time point.

If it is detected that the trigger signal is received before the second time point, proceed to step 15 of performing the second communication via the wireless network in response to the trigger signal.

Referring to FIG. 3, a flow chart of a communication method according to an embodiment of the invention is illustrated. The communication method may be applied in a terminal such as a smart television, a smart phone, a tablet, etc. The communication method includes steps 101 to 103.

Step 101: obtaining an authentication cooling threshold of a wireless network.

When the terminal performs communication by using the wireless network again after a duration longer than the authentication cooling threshold is elapsed since a successful authentication on the terminal by an authentication device, the last authentication is now invalid and the terminal is required to be authorized again by the authentication device. Preferably, the terminal may obtain the authentication cooling threshold of the wireless network. The authentication cooling threshold refers to a duration in which a valid authentication is retained since the terminal halts communicating with the wireless network after a successful authentication.

There are many approaches to obtain the authentication cooling threshold of the wireless network. For example, the terminal may measure the authentication cooling threshold of the wireless network; alternatively, the wireless network may measure the authentication cooling threshold and then send the obtained authentication cooling threshold to the terminal; or a third-party device may measure the authentication cooling threshold and send the obtained authentication cooling threshold to the terminal. The present disclosure is not limited in this aspect.

Step 102: recording a first time point of the most recent usage of the wireless network in communication.

The terminal may record a time point on which the communication between the terminal and the wireless network was accomplished as the first time point of the most recent usage of the wireless network in communication.

Step 103: using the wireless network again in communication before a duration shorter than or equal to the authentication cooling threshold is elapsed from the first time point.

The terminal may start timing at the first time point, and use the wireless network again in communication before a duration shorter than or equal to the authentication cooling threshold is elapsed. In this way, the time spent on re-authenticating the terminal by the authentication device is saved, and the RTT involved in the communication performed by the terminal using the wireless network is decreased.

Accordingly, in the communication method according to the embodiment of the invention, the wireless network is used again in communication before a duration shorter than or equal to the authentication cooling threshold is elapsed from the first time point; therefore, the problem that, a long RTT and a low communication efficiency are involved in a communication with the network if the terminal performs the communication via a persistent connection with the network, is resolved, and the efficiency of the communication is enhanced.

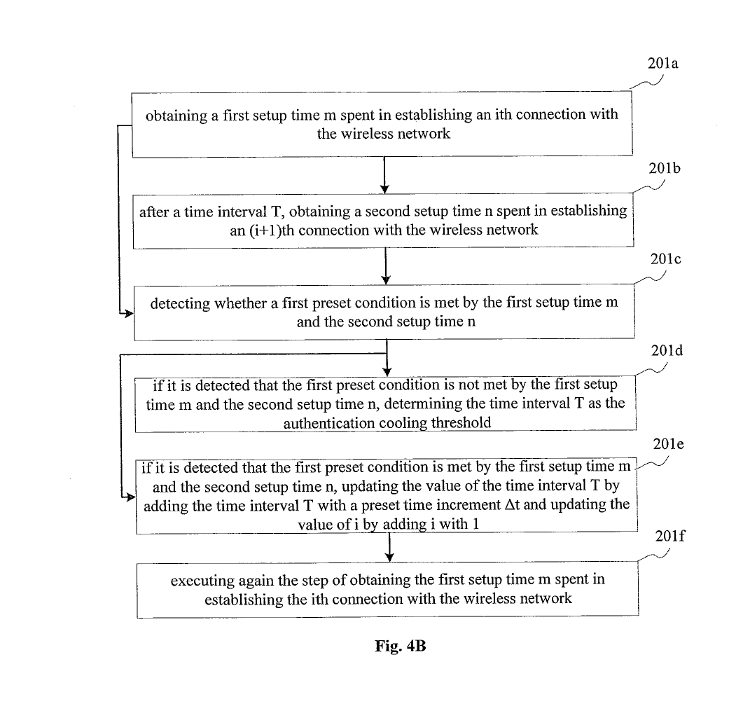

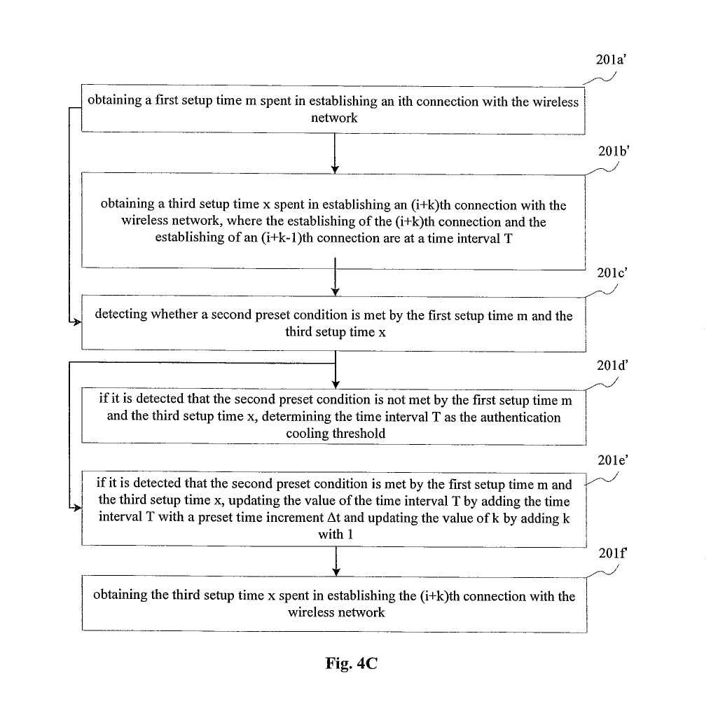

Referring to FIG. 4A, a flow chart of a communication method according to an embodiment of the invention is illustrated. The communication method may be applied in a terminal, where the terminal may be a smart television, a smart phone, a tablet, etc. The communication method includes the following steps 201-206, in which steps 201 and 202 are the same as the steps 101 and 102, respectively, and reference may be made to the description of FIG. 3.

The terminal may communicates with different wireless networks, e.g., General Packet Radio Service (GPRS) network, Wireless Fidelity (WIFI) network, etc. Because different networks have different authentication cooling thresholds, the terminal needs to measure the authentication cooling threshold of the wireless network being used currently, and uses the wireless network in communication based on the authentication cooling threshold.

There are many approaches to obtain the authentication cooling threshold of the wireless network.

This embodiment of the disclosure is described by taking the approach that the terminal measures the authentication cooling threshold of the wireless network as an example. When the terminal establishes a connection with the wireless network, the setup time spent in establishing the connection between the terminal and the wireless network is long if the terminal is required to be authorized by an authentication device, while the setup time spent in establishing the connection between the terminal and the wireless network is short if the terminal is not required to be authorized by an authentication device. Therefore, the process of obtaining the authentication cooling threshold of the wireless network may include: measuring the authentication cooling threshold based on at least two setup times spent in establishing connections with the wireless network.

Referring to FIG. 4B, a flow chart of a first method for measuring an authentication cooling threshold is illustrated. As shown in FIG. 4B, the process of measuring the authentication cooling threshold based on the at least two setup times spent in establishing the connections with the wireless network includes:

step 201a: obtaining a first setup time m spent in establishing an ith connection with the wireless network, where i≧2;

step 201b: obtaining a second setup time n spent in establishing an (i+1)th connection with the wireless network, where the establishing of the (i+1)th connection and the establishing of the ith connection are at a time interval T;

step 201c: detecting whether a first preset condition is met by the first setup time m and the second setup time n; and

step 201d: if it is detected that the first preset condition is not met by the first setup time m and the second setup time n, determining the time interval T as the authentication cooling threshold.

The setup time spent in establishing the connection in the case that a terminal is authorized is longer than the setup time spent in establishing the connection in the case that a terminal is not authorized, and the signal quality in the wireless network may affect the setup time. The setup time is shorter if the signal quality is better and the setup time is longer if the signal quality is worse. Therefore, the terminal may perform statistical analysis on a plurality of setup times, determine the relationship between the setup time spent in establishing the connection in the case that the terminal is not authorized and the setup time spent in establishing the connection in the case that the terminal is authorized, set the first preset condition based on the relationship and determine the authentication cooling threshold based on the first preset condition. There may be various first preset conditions and in the description of this embodiment the first preset condition that the second setup time n is shorter than twice the first setup time m is taken as an example.

After setting the first preset condition, the terminal may determine a shortest time interval between the connection established in the case that the terminal is not authorized and the connection established in the case that the terminal is authorized, and determine the shortest time interval as the authentication cooling threshold.

The terminal may obtain the first setup time m spent in establishing the ith connection, obtain the second setup time n spent in establishing the (i+1)th connection after the time interval T, detect whether the second setup time n is shorter than twice the first setup time m. If it is detected that the second setup time n is longer than or equal to twice the first setup time m, it is determined that the first setup time m is the setup time in the case that the terminal is not authorized and the second setup time n is the setup time in the case that the terminal is authorized, the time interval T between the ith connection and the (i+1)th connection is determined as the authentication cooling threshold.

Since the ith connection is established in the case that the terminal is not authorized, and the connection for the first time should be established in the case that the terminal is authorized because it is required to authorize the terminal by an authentication device when the terminal establishes a connection with the wireless network for the first time, it may be concluded that i≧2. When i is equal to 2, the time interval between a second connection and the first connection is shorter than the authentication cooling threshold in order that the second connection is established in the case that the terminal is not authorized. Since at this time the authentication cooling threshold is not measured by the terminal, in order to increase a probability that the second connection is established in the case that the terminal is not authorized, the time interval between the second connection and the first connection may be equal to 0.

Referring to FIG. 4B, the flow chart of the first method for measuring the authentication cooling threshold is illustrated. As shown in FIG. 4B, after the process of detecting whether the first preset condition is met by the first setup time m and the second setup time n, the method may include:

step 201e: if it is detected that the first preset condition is met by the first setup time m and the second setup time n, updating the value of the time interval T by adding the time interval T with a preset time increment Δt and updating the value of i by adding i with 1; and

step 201f: executing again the step of obtaining the first setup time m spent in establishing the ith connection with the wireless network.

If it is detected that the second setup time n is shorter than twice the first setup time m, it is determined that the first setup time m is the setup time spent in establishing the connection in the case that the terminal is not authorized, the second setup time n is the setup time spent in establishing the connection also in the case that the terminal is not authorized, and the time interval T between the ith connection and the (i+1)th connection is shorter than the authentication cooling threshold. Therefore, the value of the time interval T may be updated by adding T with the preset time increment Δt and the value of i is updated by adding i with 1, to determine again whether the first setup time m spent in the ith connection and the second setup time n spent in the (i+1)th connection satisfy the first preset condition. Until it is determined that the first preset condition is not met by the first setup time m and the second setup time n, the time interval T between the ith connection and the (i+1)th connection is determined as the authentication cooling threshold, where the ith connection corresponds to the first setup time m and the (i+1)th connection corresponds to the second setup time n.

For example, when i is equal to 2, the terminal detects whether the first setup time m used for establishing the ith, i.e., 2nd connection and the second setup time n used for establishing the (i+1)th, i.e., the 3rd connection satisfy the first preset condition; if it is detected that the first preset condition is not satisfied, the time interval T between the 2nd connection and the 3rd connection is taken as the authentication cooling threshold; if it is detected that the first preset condition is satisfied, it is continued to detect whether the first setup time m used for establishing the 3rd connection and the second setup time n used for establishing a 4th connection satisfy the first preset condition, and the like. Until it is detected that the first preset condition is met by the first setup time m and the second setup time n, the time interval T between the connection corresponding to the current first setup time m and the connection corresponding to the current second setup time n is determined as the authentication cooling threshold.

Optionally, referring to FIG. 4C, a flow chart of a second method for measuring an authentication cooling threshold is illustrated. As shown in FIG. 4C, the process of measuring the authentication cooling threshold based on the at least two setup times spent in establishing the connections with the wireless network includes:

step 201a′: obtaining a first setup time m spent in establishing an ith connection with the wireless network, where i≧2;

step 201b′: obtaining a third setup time x spent in establishing an (i+k)th connection with the wireless network, where the establishing of the (i+k)th connection and the establishing of an (i+k−1)th connection are at a time interval T, and k≧1;

step 201c′: detecting whether a second preset condition is met by the first setup time m and the third setup time x; and

step 201d′: if it is detected that the second preset condition is not met by the first setup time m and the third setup time x, determining the time interval T as the authentication cooling threshold.

A terminal may perform statistical analysis on a plurality of setup times, determine the relationship between the setup time spent in establishing the connection in the case that the terminal is not authorized and the setup time spent in establishing the connection in the case that the terminal is authorized, set the second preset condition based on the relationship and determine the authentication cooling threshold based on the second preset condition. There may be various second preset conditions and in the description of this embodiment the second preset condition that the third setup time x is shorter than twice the first setup time m is taken as an example.

After setting the second preset condition, the terminal may determine a shortest interval between the connection established in the case that the terminal is not authorized and the connection established in the case that the terminal is authorized, and determine the shortest time interval as the authentication cooling threshold.

Since the ith connection is established in the case that the terminal is not authorized, and the first connection should be established in the case that the terminal is authorized because it is required to authorize the terminal by an authentication device when the terminal establishes a connection with the wireless network for the first time, it may be concluded that i≧2. When i is equal to 2, the time interval between a second connection and the first connection is shorter than the authentication cooling threshold in order that the second connection is established in the case that the terminal is not authorized. Since at this time the authentication cooling threshold is not measured, in order to increase a probability that the second connection is established in the case that the terminal is not authorized, the time interval between the second connection and the first connection may be equal to 0.

Furthermore, the terminal establishes the (i+k)th connection, and except for the first connection, any connection before the (i+k)th connection is established in the case that the terminal is not authorized. Since the absolute value of the difference between any two setup times spent in establishing the connections in the case that the terminal is not authorized is smaller than a preset value, the terminal may determine the setup time of any connection established in the case that the terminal is not authorized as the first setup time m. Herein, the terminal may determine the setup time spent in establishing the ith connection as the first setup time m.

The terminal detects whether the third setup time x is shorter than twice the first setup time m. If it is detected that the third setup time x is longer than or equal to twice the first setup time m, the third setup time x is determined as the connection time in the case that the terminal is authorized, i.e., the (i+k)th connection is the connection established in the case that the terminal is authorized. Therefore, the terminal may determine the time interval T between the (i+k−1)th connection and the (i+k)th connection as the authentication cooling threshold.

Referring to FIG. 4C, the flow chart of the first method for measuring the authentication cooling threshold is illustrated. As shown in FIG. 4C, after the process of detecting whether the second preset condition is met by the first setup time m and the third setup time x, the method may include:

step 201e′: if it is detected that the second preset condition is met by the first setup time m and the third setup time x, updating the value of the time interval T by adding the time interval T with a preset time increment Δt and updating the value of k by adding k with 1; and

step 201f′: executing again the step of obtaining the third setup time x spent in establishing the (i+k)th connection with the wireless network.

If it is detected that the third setup time x is shorter than twice the first setup time m, it is determined that the first setup time m is the setup time spent in establishing the connection in the case that the terminal is not authorized, the third setup time x is the setup time spent in establishing the connection in the case that the terminal is not authorized, and the duration of the time interval T between the (i+k−1)th connection and the (i+k)th connection is shorter than the authentication cooling threshold. Therefore, the value of the time interval T may be updated by adding T with the preset time increment Δt and the value of k is updated by adding K with 1, to determined again whether the second preset condition is met by the first setup time m and the third setup time x. Until it is determined that the second preset condition is not met by the first setup time m and the third setup time x, the time interval T between the (i+k−1)th connection and the (i+k)th connection is determined as the authentication cooling threshold.

For example, when i is equal to 2, the terminal detects whether the first setup time m used for establishing the second connection and the second setup time n used for establishing a third connection satisfy the second preset condition; if it is detected that the second preset condition is not satisfied, the time interval T between the second connection and the third connection is taken as the authentication cooling threshold; if it is detected that the second preset condition is satisfied, it is continued to detect whether the first setup time m used for establishing the second connection and the second setup time n used for establishing a fourth connection satisfy the second preset condition, and the like. Until it is detected that the first second condition is met by the first setup time m and the second setup time n, the time interval T between the connection corresponding to the current second setup time n and a previous connection is determined as the authentication cooling threshold.

The authentication cooling threshold is usually measured in seconds; therefore, the preset time increment Δt may be set as 1 second in order to improve the accuracy in measuring the authentication cooling threshold.

Returning to FIG. 3, the method includes Step 203: determining a second time point later than the first time point by a preset time interval, where the preset time interval is shorter than the authentication cooling threshold.

The terminal may set a time point later than the first time point by the preset time interval as the second time point. Since the preset time interval is shorter than the authentication cooling threshold, the second time point is earlier than an authentication time point, to facilitate the communicate with the wireless network. The authentication time point is a time point on which the terminal is required to be authorized again by the authentication device, where the authentication time point is determined based on the first time point and the authentication cooling threshold.

Step 204: detecting whether a trigger signal is received before the second time point, where the trigger signal is generated in response to a preset operation performed on the terminal; if it is detected that the trigger signal is not received before the second time point, proceeding to step 205; if it is detected that the trigger signal is received before the second time point, proceeding to step 206.

When communicating with the wireless network, the terminal may receive an instruction generated by a button-pressing operation or a touching operation of a user, and communicate with the wireless network based on the instruction. Preferably, in order to avoid the problem of decreasing the lift time of a component in the terminal because of button-pressing operation or touching operation, the terminal may alternatively establish the connection with the wireless network automatically at the second time point.

In order to avoid the problem of large power consumption of the terminal caused by periodically using the wireless network for performing communication, the terminal may set a signal generated in response to the operation performed on the terminal as the trigger signal for establishing the connection with the wireless network. The terminal may establish the connection with the wireless network upon detecting the trigger signal.

The operation may be any operation performed on an application in the terminal. Preferably, in order to avoid the problem of establishing the connection with the wireless network frequently by the terminal because of frequently operating the application by the user, a preset operation may be set. The preset operation is not limited herein. For example, the preset operation includes at least one of switching an application in the terminal from a status of running in background to a status of running in foreground, inputting information in the application and performing, on the application, an operation of scrolling.

Step 205: using the wireless network again in communication at the second time point. The flow ends at here.

If the user does not perform an operation on the terminal before the authentication time point, the terminal is still required to be authorized by the authentication device when the next time the terminal performs communication by using the wireless network, and accordingly the RTT of the wireless network is large. Therefore, in order to avoid an authentication process performed on the terminal by the authentication device when establishing the connection and to improve the efficiency in communication, the terminal may communicate with the wireless network at the second time point which is earlier than the authentication time point.

There are many approaches for the terminal to perform communication by using the wireless network again at the second time point. For example, the terminal may send data via a connection with the wireless network again to implement communication again; or the terminal may establish the connection with the wireless network and take a process of establishing the connection as a process of performing communication by using the wireless network again; etc. The approach for the terminal to perform communication by using the wireless network again is not restricted herein.

In the case that the terminal performs communication via a connection with the wireless network, the connection may be either already established and retained or may be newly established. The step of using the wireless network again in communication at the second time point may include:

step 205a: performing communication via a first connection continuously retained with the wireless network, where the first connection is established in the most recent usage of the wireless network in communication; or,

step 205b: establishing a second connection with the wireless network and performing communication via the second connection.

Optionally, the connection established between the terminal and the wireless network at the second time point may be either a persistent connection or a transitory connection, and the present disclosure is not limited in this aspect. The process of establishing the connection between the terminal and the wireless network is well known and is not described in detail herein.

If the terminal needs to perform communication again via an established connection, the connection may be retained to save the setup time spent in establishing the connection between the terminal and the wireless network for the next time. If the terminal does not need to perform communication again via the established connection, the connection may be disconnected in order to save the system resource occupied for retaining the connection.

Furthermore, the terminal may determine the time point on which the wireless network is used in communication as a new first time point, and may determine, according to the new first time point and the authentication cooling threshold, a new time point on which the terminal is required to be authorized again by the authentication device; accordingly, a time point on which the terminal is required to be authorized by the authentication device is delayed by this communication, the terminal is not required to be authorized by the authentication device when the terminal performs communication by using the wireless network again in the delayed time period, and the RTT involved in the communication performed by the terminal using the wireless network is reduced.

Step 206: using the wireless network again in communication in response to the trigger signal.

There are many approaches for the terminal to communicate with the wireless network again in response to the trigger signal. For example, the terminal may send data again in response to the trigger signal via a connection between the terminal and the wireless network to implement communication again; or the terminal may establish the connection with the wireless network in response to the trigger signal, and take a process of establishing the connection as a process of performing communication again by using the wireless network. The approach for the terminal to communicate with the wireless network again in response to the trigger signal is not restricted herein.

In the case that the terminal performs communication via a connection with the wireless network, the connection may be either already established and retained or newly established. The step of using the wireless network again in communication in response to the trigger signal may include:

step 206a: after the trigger signal is received, performing communication via a first connection continuously retained with the wireless network, where the first connection is established in the most recent usage of the wireless network in communication; or

step 206b: after the trigger signal is received, establishing a third connection with the wireless network and performing communication via the third connection.

Optionally, the connection established between the terminal and the wireless network at the second time point may be either a persistent connection or a transitory connection, and the present disclosure is not limited in this aspect. The process of establishing the connection between the terminal and the wireless network is well known and is not described in detail herein.

If the terminal needs to perform communication again via an established connection, the connection may be retained to save the setup time spent in establishing the connection between the terminal and the wireless network for the next time. If the terminal does not need to perform communication again via the established connection, the connection may be disconnected in order to save the system resource occupied for retaining the connection.

Furthermore, the terminal may determine the time point on which the wireless network is used in communication as a new first time point, and may determine, according to the new first time point and the authentication cooling threshold, a new time point on which the terminal is required to be authorized again by the authentication device; accordingly, a time point on which the terminal is required to be authorized by the authentication device is delayed by this communication, the terminal is not required to be authorized by the authentication device when the terminal performs communication by using the wireless network again in the delayed time period, and the RTT involved in the communication performed by the terminal using the wireless network is reduced.

Accordingly, in the communication method according to the embodiment of the invention, the wireless network is used again in communication before a duration shorter than or equal to the authentication cooling threshold is elapsed from the first time point; therefore, the problem that, a long RTT and a low communication efficiency are involved in a communication with the network if the terminal performs the communication via a persistent connection with the network, is resolved, and the efficiency of the communication is enhanced. In addition, by determining a second time point later than the first time point by a preset time interval shorter than the authentication cooling threshold and performing communication again with the wireless network on the second time point, the communication with the wireless network may be retained periodically, the problem of decreasing the life time of the components in the terminal because of retaining the connection with the wireless network by performing a button-pressing operation or a touching operation on the terminal, is solved, and the life time of the components in the terminal is prolonged.

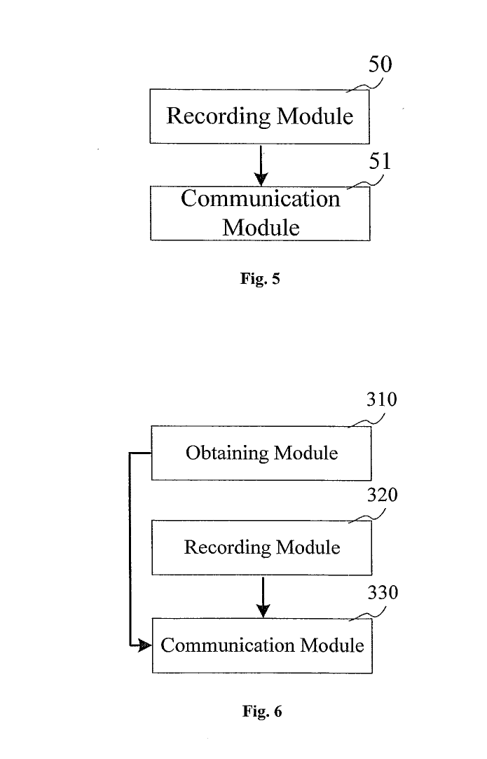

Referring to FIG. 5, a block diagram showing the structure of a communication apparatus according to an embodiment of the invention is illustrated. The communication apparatus may be applied in a terminal, where the terminal may be a smart television, a smart phone, a tablet, etc. The communication apparatus includes:

a recording module 50, configured to record a first time point of a first communication performed via a wireless network; and

a communication module 51, configured to performing a second communication via the wireless network before a duration shorter than or equal to an authentication cooling threshold is elapsed from the first time point recorded by the recording module, where the authentication cooling threshold is associated with a duration in which a valid authentication of the terminal by the wireless network is retained.

Referring to FIG. 6, a block diagram showing the structure of a communication apparatus according to an embodiment of the invention is illustrated. The communication apparatus may be applied in a terminal, where the terminal may be a smart television, a smart phone, a Tablet, etc. The communication apparatus includes:

an obtaining module 310, configured to obtain an authentication cooling threshold of a wireless network;

a recording module 320, configured to record a first time point of the most recent usage of the wireless network in communication; and

a communication module 330, configured to, after the recording module 320 records the first time point, use the wireless network again in communication before a duration shorter than or equal to the authentication cooling threshold is elapsed from the first time point recorded by the recording module 320.

Accordingly, in the communication apparatus according to the embodiment of the invention, the wireless network is used again in communication before a duration shorter than or equal to the authentication cooling threshold is elapsed from the first time point; therefore, the problem that, a long RTT and a low communication efficiency are involved in a communication with the network if the terminal performs the communication via a persistent connection with the network, is resolved, and the efficiency of the communication is enhanced.

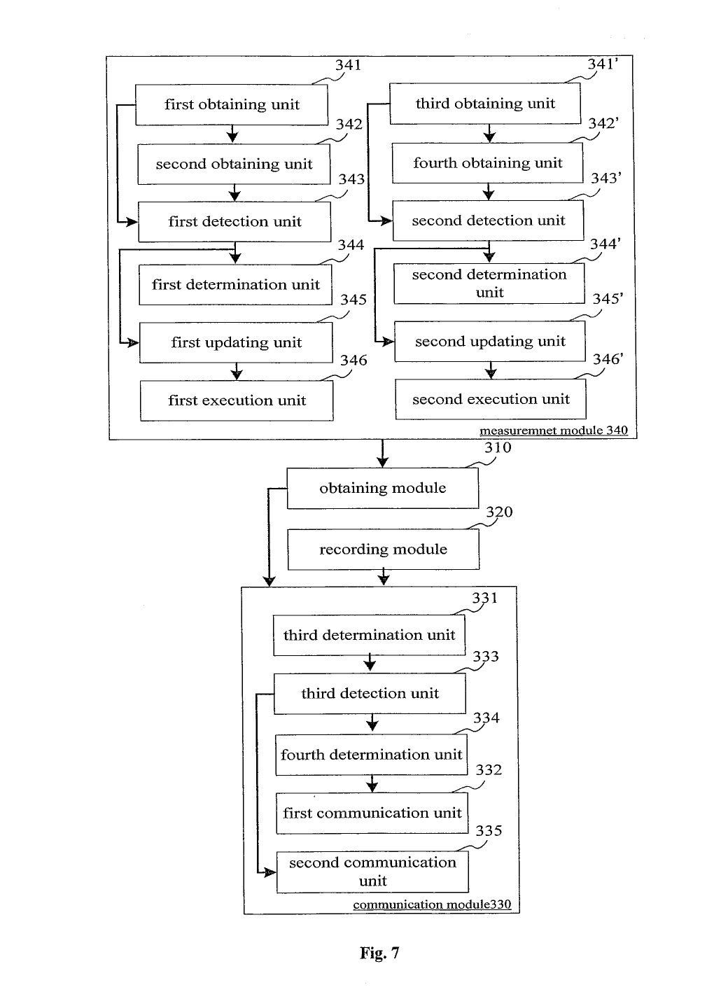

Referring to FIG. 7, a block diagram showing the structure of a communication apparatus according to an embodiment of the invention is illustrated. The communication apparatus may be applied in a terminal, where the terminal may be a smart television, a smart phone, a tablet, etc.

The communication apparatus differs from that as shown in FIG. 7 in that the communication apparatus may further include:

a measurement module 340, configured to, before the obtaining module 310 obtains the authentication cooling threshold of the wireless network, measure the authentication cooling threshold based on at least two setup times spent in establishing connections with the wireless network.

Furthermore, the measurement module 340 may include:

a first obtaining unit 341, configured to obtain a first setup time m spent in establishing an ith connection with the wireless network, where i>2;

a second obtaining unit 342, configured to obtain, after the first setup time m is obtained by the first obtaining unit 341, a second setup time n spent in establishing an (i+1)th connection with the wireless network, where there is a time interval T between the (i+1)th connection and the ith connection;

a first detection unit 343, configured to detect whether the first setup time m obtained by the first obtaining unit 341 and the second setup time n obtained by the second obtaining unit 342 satisfy a first preset condition; and

a first determination unit 344, configured to, if it is detected by the first detection unit 343 that the first preset condition is not met by the first setup time m and the second setup time n, determine the time interval T as the authentication cooling threshold.

Furthermore, the measurement module 340 may further include:

a first updating unit 345, configured to, if it is detected, by the first detection unit 343, that the first preset condition is met by the first setup time m and the second setup time n, update the time interval T by adding the time interval T with a preset time increment Δt and update the value of i by adding i with 1; and

a first execution unit 346, configured to execute again, after the time interval T and the parameter i are updated by the first updating unit 345, a step of obtaining the first setup time m spent in establishing the ith connection with the wireless network.

Furthermore, the first preset condition is that, the second setup time n is shorter than twice the first setup time m.

Furthermore, the measurement module 340 may include:

a third obtaining unit 341′, configured to obtain a first setup time m spent in establishing an ith connection with the wireless network, where i≧2;

a fourth obtaining unit 342′, configured to obtain, a third setup time x spent in establishing an (i+k)th connection with the wireless network, where the establishing of the (i+k)th connection and the establishing of an (i+k−1)th connection are at a time interval T, and k≧1;

a second detection unit 343′, configured to detect whether the first setup time m obtained by the third obtaining unit 341′ and the third setup time x obtained by the fourth obtaining unit 342′ satisfy a second preset condition; and

a second determination unit 344′, configured to determine the time interval T as the authentication cooling threshold if it is detected, by the second detection unit 343′, that the second preset condition is not met by the first setup time m and the third setup time x.

Furthermore, the measurement module 340 may further include:

a second updating unit 345′, configured to update the time interval T by adding the time interval T with a preset time increment Δt and update the value of k by adding k with 1, if it is detected, by the second detection unit 343′, that the second preset condition is met by the first setup time m and the third setup time x; and

a second execution unit 346′, configured to execute again, after the time interval T and the parameter i are updated by the second updating unit 345′, the step of obtaining the third setup time x spent in establishing the (i+k)th connection with the wireless network.

Furthermore, the second preset condition is that, the third setup time x is shorter than twice the first setup time m.

Furthermore, the communication module 330 may include:

a third determination unit 331, configured to determine a second time point later than the first time point by a preset time interval, where the preset time interval is shorter than the authentication cooling threshold; and

a first communication unit 332, configured to using the wireless network again in communication at the second time point determined by the third determination unit 331.

Furthermore, the first communication unit 332 is configured to perform communication via a first connection continuously retained with the wireless network, where the first connection is established in the most recent usage of the wireless network in communication; or establish a second connection with the wireless network and perform communication via the second connection.

Furthermore, the communication module 330 may further include:

a third detection unit 333, configured to detect whether a trigger signal is received before the second time point, where the trigger signal is generated in response to a preset operation performed on the terminal;

a fourth determination unit 334, configured to, if it is detected, by the third detection unit 333, that the trigger signal is not received before the second time point, determine that the step of using the wireless network again in communication at the second time point is to be executed; and

a second communication unit 335, configured to, if it is detected, by the third detection unit 333, that the trigger signal is received before the second time point, using the wireless network again in communication in response to the trigger signal.

Furthermore, the preset operation includes at least one of switching an application in the terminal from a status of running in background to a status of running in foreground, inputting information in the application, and performing, on the application, an operation of scrolling.

Furthermore, the second communication unit 335 is configured to, after the trigger signal is received, perform communication via a first connection continuously retained with the wireless network, where the first connection is established in the most recent usage of the wireless network in communication; or, after the trigger signal is received, establish a third connection with the wireless network and perform communication via the third connection.

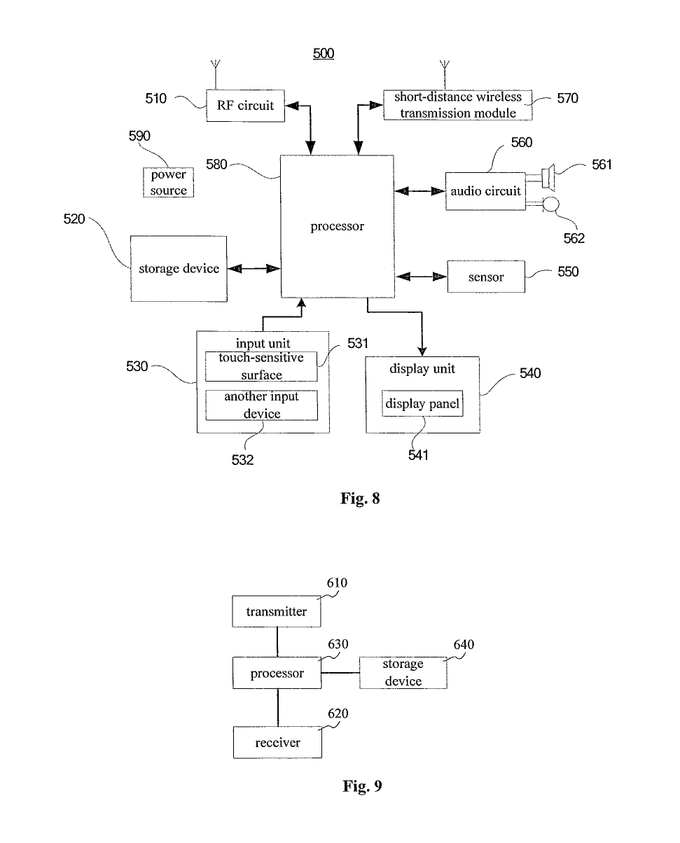

Referring to FIG. 8, a block diagram showing the structure of an electronic device according to an embodiment of the invention is illustrated. The electronic device is applied in the communication method according to the embodiments.

An electronic device 500 may include: a Radio frequency (RF) circuit 510, a storage device 520 including one or more computer readable storage mediums, an input unit 530, a display unit 540, a sensor 550, an audio circuit 560, a short-distance wireless transmission module 570, a processor 580 including one or more processing cores, a power supply 590, etc. It should be understood by those skilled in the art that, the structure of the electronic device shown in FIG. 8 is not intended to limit the electronic device, more or less components than shown in FIG. 8 may be included, some components may be combined, or the components may be in another arrangement.

The RF circuit 510 may be configured to receive and send signals during receiving and sending messages or during making a phone call, and in particular, deliver downlink information of a base station to one or more processors 580 to process, and send uplink data to the base station. Usually, the RF circuit 510 includes, but not limited to, an antenna, at least one amplifier, a tuner, one or more oscillators, a Subscriber Identity Module (SIM) card, a transceiver, a coupler, a Low Noise Amplifier (LNA), a duplexer, etc. In addition, the RF circuit 510 may communicate with a network or other devices through wireless communication. Any communication standard or protocol may be adopted for the wireless communication, the communication standard or protocol includes but not limited to: Global System of Mobile communication (GSM), General Packet Radio Service (GPRS), Code Division Multiple Access (CDMA), Wideband Code Division Multiple Access (WCDMA), Long Term Evolution (LTE), Email, Short Messaging Service (SMS), etc.

The storage device 520 may be configured to store a software program and module. The processor 580 executes different applications and processes data by running the software program and module stored in the storage device 520. The storage device 520 may mainly include a program storage area and a data storage area, where the program storage area may store an operating system, an application program required for at least one function (e.g., a function of playing audio, a function of displaying image, etc.), etc.; the data storage area may store data (e.g., audio data, telephone book, etc.) created based on the usage of the electronic device 500, etc. In addition, the storage device 520 may include a high speed random access memory, a nonvolatile storage such as at least one magnetic disk storage or flash disk, and any solid volatile storage. Correspondingly, the storage device 520 may include a storage controller, which is configured to enable the processor 580 and the input unit 530 to access the storage device 520.

The input unit 530 may be configured to receive an input number or input character information, and generate a signal input through a keyboard, a mouse, an operating rod, an optical input device or a trackball, where the signal is associated with user configuration and function control. The input unit 530 may include a touch-sensitive surface 531 and another input device 532. The touch-sensitive surface 531, also known as a touch screen or touch panel, may capture a touch operation performed on or nearby the surface (e.g., an operation performed on or near the touch-sensitive surface 531 by a user with a finger, a stylus or any suitable object or accessory), and drive a corresponding connection device based on a preset program. Optionally, the touch-sensitive surface 531 may include two components: a touch detection apparatus and a touch controller. The touch detection apparatus is configured to detect a touch location of the user, detect the signal caused by the touch operation, and send the signal to the touch controller; the touch controller is configured to receive touch information from the touch detection device, turn the touch information into coordinates of a touch point, send the coordinates to the processor 580, and receive and execute a command from the processor 580. In addition, the touch-sensitive surface 531 may be implemented into many types, e.g., a resistance type, an infrared type, a Surface Acoustic Wave type, etc. Besides the touch-sensitive surface 531, the input unit 530 may include another input device 532. The another input device 532 includes but not limited to: any one of physical keyboard, function key (e.g., key for controlling volume, ON/OFF key, etc.), trackball, mouse and operating rod or a combination thereof.

The display unit 540 is configured to display information input by the user, information provided to the user and different graphic user interfaces of the electronic device 500, where those graphic user interfaces may include image, text, icon, video and any combination thereof. The display unit 540 may include a display panel 541, and optionally, the display panel 541 may be configured in forms of Liquid Crystal Display (LCD), Organic Light-Emitting Diode (OLED), etc. Furthermore, the touch-sensitive surface 531 may cover the display panel 541, and after the touch operation is detected on or near the touch-sensitive surface 531, the touch information is sent to the processor 580 to determine the type of a touch event, then the processor 580 provides a corresponding visual output on the display panel 541 based on the type of the touch event. Although in FIG. 8, the touch-sensitive surface 531 and the display panel 541 are implemented as two independent components to achieve input and output, the touch-sensitive surface 531 and the display panel 541 may be integrated together to achieve input and output according to some embodiments of the disclosure.

The electronic device 500 may further include at least one kind of sensor 550, e.g., optical sensor, motion sensor and any other sensors. The optical sensor may include an ambient light sensor and a proximity sensor, where the ambient light sensor may adjust the brightness of the display panel 541 based on the intensity of ambient light, and the proximity sensor may turn off the display panel 541 and/or a backlight when the electronic device 500 is moved near to an ear. As one kind of the motion sensor, a gravity acceleration sensor may detect values of accelerations on all directions (usually three-axis), and detect the value and direction of the gravity when remaining stationary; the gravity acceleration sensor may be applied in an application for recognizing posture of a mobile phone (for example, switching between landscape and portrait, a relevant game, magnetometer pose calibration), a function related to vibration recognition (for example, a pedometer, knocking), etc.; in addition, other sensors, e.g., gyroscope, barometer, hygrometer, thermometer, infrared sensor, etc., may be further provided in the electronic device 500, the description of which is omitted herein.

The audio circuit 560, a loudspeaker 561 and a microphone 562 may provide an audio interface between the user and the electronic device 500. The audio circuit 560 may transmit an electric signal, converted from received audio data, to the loudspeaker, and a voice signal is converted from the electric signal and is output, by the loudspeaker; on the other hand, the microphone converts captured voice signal into an electric signal, the electric signal is received by the audio circuit 560 and converted into audio data. Alternatively, the audio data is output to the processor 580 to process and then sent to another terminal via the RF circuit 510; alternatively, the audio data is output to the storage 520 for further processing. The audio circuit 560 may further include a headset jack through which an external earphone and the electronic device 500 may be connected.

The short-distance wireless transmission module 570 may be a Wireless Fidelity module or a Bluetooth module, etc. With the short-distance wireless transmission module 570, the electronic device 500 may insist the user in receiving and sending an email, browsing a web page, accessing a stream media, etc., and a wireless broadband Internet access is provided to the user. Although the short-distance wireless transmission module 570 is shown in FIG. 8, it should be understood that the short-distance wireless transmission module is not indispensable in the electronic device 500 and may be omitted in practice without changing the essence of the disclosure.

The processor 580, as a control center of the electronic device 500, and is connected to all components of the whole electronic device via different interfaces and wires, and execute different functions of the electronic device and process the data, by running or executing the software program and/or module stored in the storage 520, and invoking the data stored in the storage 520; therefore, the whole electronic device is monitored. Optionally, the processor 580 may include one or more processing cores; preferably, the processor 580 may be integrated with an application processor and a modem processor, where the application processor is mainly responsive of processing involved with the operating system, the user interface, the applications, etc., and the modem processor is mainly responsive of processing involved with the wireless communication. It may be understood that, alternatively, the modem processor may not be integrated in the processor 580.

The electronic device 500 further includes the power supply 590 (such as a battery) providing power to all the components. Preferably, the power supply may be connected to the processor 580 logically through a power management system in order to implement functions of charging management, discharging management, power consumption management, etc. The power supply 590 may further include elements such as one or more direct-current or alternating current power supplies, a recharging system, a power failure detection circuit, a power adapter or inverter, a power status indicator, etc.

The electronic device 500 may include, although not shown, a camera, a bluetooth module, etc., for which the description is omitted. According to the embodiment of the disclosure, the display unit of the electronic device 500 is a touch screen display.

The electronic device 500 further includes a storage and one or more programs, where the one or more programs are stored in the storage and are configured to be executed by one or more processors. Instructions included in the one or more programs are configured to implement a communication method, where the communication method may be the communication methods illustrated in FIGS. 1, 2, 3 and 4A, or the communication method described in the embodiment corresponding to FIGS. 1, 2, 3 and 4A.

Referring to FIG. 9, a schematic structure diagram of an electronic device according to an embodiment of the invention is illustrated. The electronic device includes a transmitter 610, a receiver 620, a processor 630, a storage device 640, and one or more programs, where the one or more programs are stored in the storage 640, and are configured to be executed by one or more processors 630. Instructions included in the one or more programs are configured to implement a communication method, where the communication method may be the communication method illustrated in FIGS. 1, 2, 3 and 4A, or the communication method described in the embodiment corresponding to FIGS. 1, 2, 3 and 4A.

In another aspect, a computer readable storage medium is further provided according to an embodiment of the invention. The computer readable storage medium may be the computer readable storage medium included in the storage device according to the embodiment above; or the computer readable storage medium may be a stand-alone medium not being assembled into an electronic device or a server. One or more programs are stored in the computer readable storage medium, the one or more programs are executed by one or more processors to implement a communication method, and instructions included in the one or more programs are configured to implement a communication method, such as the communication method illustrated in FIGS. 1, 2, 3 and 4A, or the communication method described in the embodiment corresponding to FIGS. 1, 2, 3 and 4A.

It should be understood that, although terms of “first”, “second”, etc. are used to describe elements in the specification, those terms are not intended to limit the elements, and those terms are only used to distinguish the elements. It should also be understood that, unless expressively specified otherwise in the context, terms of “a”, “an” and “the” written in singular forms, are intended to include the plural forms. It should be understood that, a term of “and/or” used in the specification means any possible combination of one or more listed items.

Serial numbers of the embodiments are only for illustration, merits of the embodiments may not be reflected by the serial numbers.

It should be understood by those skilled in the art that, part or all of the steps according to the embodiments may be performed through a hardware, or a corresponding hardware instructed with a program, where the program may be stored in a computer readable storage medium, and the computer readable storage medium may include: Read Only Memory, magnetic disk, Compact Disk, etc.

The embodiments in the invention are merely preferred embodiments and are not intended to limit the disclosure. Any changes, equivalent replacements, modification, etc. obtained without departing from the spirit and principle of the disclosure shall fall into the scope of protection of the disclosure.

What is claimed is:

1. A communication method comprising:
recording, by a terminal comprising a processor, a first time point of a first communication between the terminal and a wireless network; and
performing, by the terminal, a second communication between the terminal and the wireless network before a duration shorter than or equal to an authentication cooling threshold from the first time point is elapsed, wherein the authentication cooling threshold is associated with a duration in which a valid authentication of the terminal by the wireless network is retained.

2. The communication method according to claim 1, further comprising:
measuring the authentication cooling threshold based on at least two setup times spent in establishing connections with the wireless network.

3. The communication method according to claim 2, wherein measuring the authentication cooling threshold based on at least two setup times spent in establishing connections with the wireless network comprises:
obtaining a first setup time m spent in establishing an ith connection with the wireless network, wherein i≧2;
obtaining a second setup time n spent in establishing an (i+1)th connection with the wireless network, wherein the establishing of the (i+1)th connection and the establishing of the ith connection are at a time interval T;
detecting whether a first preset condition is met by the first setup time m and the second setup time n; and
determining the time interval T as the authentication cooling threshold if it is detected that the first preset condition is not met by the first setup time m and the second setup time n.

4. The communication method according to claim 3, wherein after detecting whether the first preset condition is met by the first setup time m and the second setup time n, the method further comprises:
updating the value of the time interval T by adding the time interval T with a preset time increment Δt and updating the value of i by adding i with 1, if it is detected that the first preset condition is met by the first setup time m and the second setup time n; and
executing again the step of obtaining the first setup time m spent in establishing the ith connection with the wireless network.

5. The communication method according to claim 3, wherein the first preset condition is that, the second setup time n is shorter than twice the first setup time m.

6. The communication method according to claim 2, wherein measuring the authentication cooling threshold based on at least two setup times spent in establishing connections with the wireless network comprises:
obtaining a first setup time m spent in establishing an ith connection with the wireless network, wherein i≧2;
obtaining a third setup time x spent in establishing an (i+k)th connection with the wireless network, wherein the establishing of the (i+k)th connection and the establishing of an (i+k−1)th connection are at a time interval T, wherein k≧1;
detecting whether a second preset condition is met by the first setup time m and the third setup time x; and
determining the time interval T as the authentication cooling threshold if the second preset condition is not met by the first setup time m and the third setup time x.

7. The communication method according to claim 6, wherein after detecting whether the second preset condition is met by the first setup time m and the third setup time x, the method further comprises:
updating the value of the time interval T by adding the time interval T with a preset time increment Δt and updating the value of k by adding k with 1, if the second preset condition is met by the first setup time m and the third setup time x; and
executing again the step of obtaining the third setup time x spent in establishing the (i+k)th connection with the wireless network.

8. The communication method according to claim 6, wherein the second preset condition is that, the third setup time x is shorter than twice the first setup time m.

9. The communication method according to claim 1, wherein the step of performing the second communication between the terminal and the wireless network before a duration shorter than or equal to the authentication cooling threshold from the first time point is elapsed comprises:
determining a second time point later than the first time point by a preset time interval, wherein the preset time interval is shorter than the authentication cooling threshold; and
performing the second communication between the terminal and the wireless network at the second time point.

10. The communication method according to claim 9, wherein performing the second communication between the terminal and the wireless network at the second time point comprises at least one of:
performing the second communication via a first connection continuously retained with the wireless network, wherein the first connection is established in the most recent usage of the wireless network; and
establishing a second connection with the wireless network and performing the second communication via the second connection.

11. The communication method according to claim 9, wherein before performing the second communication between the terminal and the wireless network at the second time point, the method further comprises:
detecting whether a trigger signal is received before the second time point, wherein the trigger signal is generated in response to a preset operation performed on the terminal; and
determining to execute the step of performing the second communication between the terminal and the wireless network at the second time point if the trigger signal is not received before the second time point; or performing the second communication between the terminal and the wireless network in response to the trigger signal if the trigger signal is received before the second time point.

12. The communication method according to claim 11, wherein the preset operation comprises at least one of: switching an application in the terminal from a status of running in background to a status of running in foreground, inputting information in the application, and performing, on the application, an operation of scrolling.

13. The communication method according to claim 11, wherein performing the second communication between the terminal and the wireless network in response to the trigger signal comprises at least one of:
after the trigger signal is received, performing the second communication via a first connection continuously retained with the wireless network, wherein the first connection is established in the most recent usage of the wireless network in communication; and
after the trigger signal is received, establishing a third connection with the wireless network and performing the second communication via the third connection.

14. A communication apparatus comprising:
a recording module comprising a processor, configured to record a first time point of a first communication between the communication apparatus and a wireless network; and
a communication module comprising a processor, configured to perform a second communication between the communication apparatus and the wireless network before a duration shorter than or equal to an authentication cooling threshold from the first time point recorded by the recording module is elapsed, wherein the authentication cooling threshold is associated with a duration in which a valid authentication of the communication apparatus by the wireless network is retained.

15. The communication apparatus according to claim 14, wherein the communication apparatus further comprises:
a measurement module comprising a processor, configured to measure the authentication cooling threshold based on at least two setup times spent in establishing connections with the wireless network.

16. The communication apparatus according to claim 15, wherein the measurement module comprises:
a first obtaining unit, configured to obtain a first setup time m spent in establishing an ith connection with the wireless network, wherein i≧2;
a second obtaining unit, Configured to obtain a second setup time n spent in establishing an (i+1)th connection with the wireless network, wherein the establishing of the (i+1)th connection and the establishing of the ith connection are at a time interval T;
a first detection unit, configured to detect whether a first preset condition is met by the first setup time m and the second setup time n; and
a first determination unit, configured to, if it is detected by the first detection unit that the first preset condition is not met by the first setup time m and the second setup time n, determine the time interval T as the authentication cooling threshold.

17. The communication apparatus according to claim 16, wherein the measurement module further comprises:
a first updating unit, configured to, if the first detection unit detects that the first preset condition is met by the first setup time m and the second setup time n, update the time interval T by adding the time interval T with a preset time increment Δt and update the value of i by adding i with 1; and
a first execution unit, configured to execute again, after the time interval T and the parameter i are updated by the first updating unit, the step of obtaining the first setup time m spent in establishing the ith connection with the wireless network.

18. The communication apparatus according to claim 15, wherein the measurement module comprises:
a third obtaining unit, configured to obtain a first setup time m spent in establishing an ith connection with the wireless network, wherein i≧2;
a fourth obtaining unit, configured to obtain, after the first setup time m is obtained in the third obtaining unit, a third setup time x spent in establishing an (i+k)th connection with the wireless network, wherein the establishing of the (i+k)th connection and the establishing of an (i+k−1)th connection are at a time interval T, wherein k≧1;
a second detection unit, configured to detect whether a second preset condition is met by the first setup time m and the third setup time x; and
a second determination unit, configured to determine the time interval T as the authentication cooling threshold if it is detected, by the second detection unit, that the second preset condition is not met by the first setup time m and the third setup time x.

19. The communication apparatus according to claim 18, wherein the measurement module further comprises:
a second updating unit, configured to update the time interval T by adding the time interval T with a preset time increment Δt and update the value of k by adding k with 1, if it is detected, by the second detection unit, that the second preset condition is met by the first setup time m and the third setup time x; and
a second execution unit, configured to execute again, after the time interval T and the parameter k are updated by the second updating unit, the step of obtaining the third setup time x spent in establishing the (i+k)th connection with the wireless network.

20. A terminal, comprising a communication apparatus, wherein the communication apparatus comprises:
a recording module comprising a processor, configured to record a first time point of a first communication between the terminal and a wireless network; and
a communication module comprising a processor, configured to performing a second communication between the terminal and the wireless network before a duration shorter than or equal to an authentication cooling threshold from the first time point recorded by the recording module is elapsed, wherein the authentication cooling threshold is associated with a duration in which a valid authentication of the terminal by the wireless network is retained.
